(19) United States
(12) Patent Application Publication
(10) Pub. No.: US 2015/0289110 A1
(43) Pub. Date: Oct. 8, 2015

(54) MOBILE DEVICE DEFINED TRACKING AREA

(71) Applicant: QUALCOMM Incorporated, San Diego, CA (US)

(72) Inventors: Thomas Kilpatrick, II, San Diego, CA (US); Roy Franklin Quick, JR., San Diego, CA (US); Olufunmilola Awoniyi-Oteri, San Diego, CA (US)

(21) Appl. No.: 14/747,623

(22) Filed: Jun. 23, 2015

Related U.S. Application Data
(63) Continuation-in-part of application No. 14/621,443, filed on Feb. 13, 2015.
Application No. 14/621,443 is a continuation-in-part of application No. 14/279,147, filed on May 15, 2014.
(60) Provisional application No. 61/860,789, filed on Jul. 31, 2013.

(51) Int. Cl. H04W 4/02; H04W 4/04; H04W 64/00

(52) U.S. Cl. CPC H04W 4/028; H04W 4/027; H04W 64/006; H04W 4/046; H04W 84/042

(57) ABSTRACT

Methods, systems, and devices are described for defining a tracking area for a mobile device. The mobile device may determine that it is traveling along an identified route. The mobile device may send an indication to a core cellular network that it is traveling along the identified route and, therefore, refrain from sending tracking area update messages as it enters new tracking areas along the route. The core cellular network may receive the message and define a tracking area for the mobile device based on the information associated with the identified route. The core cellular network may define the tracking area and send page(s) to the mobile device without receiving tracking area update reporting messages from the mobile device as it travels along the identified route.

CROSS REFERENCES

The present Application for Patent is a continuation-in-part of U.S. patent application Ser. No. 14/621,443 by Kilpatrick et al., entitled “Mobile Device Defined Tracking Area,” filed Feb. 13, 2015, which is a continuation-in-part of U.S. patent application Ser. No. 14/279,147 filed May 15, 2014, entitled “Paging Area Reduction Based Predictive Mobility,” which claims priority to U.S. Provisional Patent Application No. 61/860,789, filed Jul. 31, 2013, entitled “Predictive Mobility In Cellular Networks.” The entire disclosure of each of the aforementioned applications is incorporated herein by reference for all purposes.

BACKGROUND

1. Field of the Disclosure

The present disclosure, for example, relates to wireless communication systems, and more particularly to defining a tracking area for a mobile device based on the mobile device traveling along a route.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communications system may include a number of base stations, each simultaneously supporting communication for multiple wireless devices. Base stations may communicate with wireless devices on downstream and upstream links. Each base station has a coverage range, which may be referred to as the coverage area of the cell. A network, e.g., the core cellular network, may define one or more tracking areas as paging areas and assign some or all of the cells within the geographic area as a tracking area group. The network typically assigns the cells to the tracking area to provide a level of abstraction regarding the location of the mobile device. Generally, the tracking area group may be assigned to the mobile device which may allow the network to identify one or more cells on which to page the mobile device.

Upon entering a new tracking area, a mobile device may typically send location area update messages to the network. The network responds by assigning the mobile device to the new tracking area and sends pages, when necessary, to the mobile device on the last known cell (e.g., the first cell the mobile device contacts in the new tracking area). If that page is unsuccessful, e.g., the mobile device does not respond, the network sends the page to each cell assigned to the new tracking area. Current implementations, however, do not consider route information associated with the mobile device and, therefore, may utilize unnecessary messaging as the mobile device enters each new tracking area, thereby increasing overhead messaging for the network and power consumption for the mobile device.

SUMMARY

The described features generally relate to one or more improved systems, methods, and/or apparatuses for a core cellular network to define or otherwise identify a tracking area of the mobile device based on knowledge that the mobile device is traveling along an identified route. The route that the mobile device is traveling may be dynamically determined, e.g., based on a user entering a destination address into a navigational application, based on the mobile device entering a vehicle that traverses a particular route, etc. The mobile device may communicate, directly or indirectly, an indication to the core cellular network that it is traveling along the identified route. The indication may include information associated with the identified route, e.g., a physical path corresponding to the identified route, the time the mobile device began traveling along the identified route, etc. The core cellular network may define the tracking area for the mobile device based on the information associated with the identified route.

Accordingly, the network may determine where the mobile device is along the route at any given instant, to a certain degree of accuracy, and send a page to the mobile device based on the defined tracking area of the mobile device. The mobile device may withhold tracking area updates as the mobile device enters new tracking areas along to route, e.g., provides for the mobile device to withhold its tracking area updates while traveling on its route. Accordingly, the mobile device and network may leverage knowledge that the mobile device is traveling along a particular route to avoid unnecessary messaging, but yet maintain locational awareness of the mobile device.

In a first illustrative set of example, a method for wireless communication is provided. The method may include: communicating, to a core cellular network, an indication that a mobile device is traveling along an identified route; and refraining, by the mobile device, from transmitting a tracking area update message to the core cellular network while traveling along the identified route based at least in part on the communication to the core cellular network.

In some aspects, the method may include identifying the route based at least in part on application layer data associated with at least one of the mobile device or a device communicatively coupled with the mobile device. The method may include initiating a navigation application to identify the identified route; wherein the application layer data associated with the mobile device may include data from the navigation application.

In some aspects, the method may include determining that a plurality of mobile devices are traveling along the identified route; and including information identifying the plurality of mobile devices in the communication to the core cellular network. The method may include communicating a message to the plurality of mobile devices indicating that the plurality of mobile devices are to refrain from transmitting tracking area update messages to the core cellular network. The information identifying the plurality of mobile devices may include a cellular telephone number associated with each of the mobile devices.

In some aspects, the method may include communicating an indication to the core cellular network that the mobile device has arrived at a destination location of the identified route. The indication that the mobile device has arrived at the destination location may include a tracking area update message. The method may include communicating to the core cellular network an indication that the mobile device has traveled at least a threshold distance outside of the identified route.

In some aspects, the mobile device is traveling along the identified route in a vehicle, and wherein communicating the indication that the mobile device is traveling along the identified route may include communicating with a wireless system of the vehicle, wherein the wireless system of the vehicle is configured to provide the indication that the mobile device is traveling along the identified route to the core cellular network. The method may include determining the identified route based at least in part on identification information associated with the vehicle.

In a second illustrative set of examples, an apparatus for wireless communication is provided. The apparatus may include: a processor; and memory in electronic communication with the processor, the memory embodying instructions, the instructions executable by the processor to: communicate, to a core cellular network, an indication that a mobile device is traveling along an identified route; and refrain, by the mobile device, from transmitting a tracking area update message to the core cellular network while traveling along the identified route based at least in part on the communication to the core cellular network.

In some aspects, the apparatus may include instructions executable by the processor to identify the route based at least in part on application layer data associated with at least one of: the mobile device or a device communicatively coupled with the mobile device. The apparatus may include instructions executable by the processor to: initiate a navigation application to identify the identified route; wherein the application layer data associated with the mobile device may include data from the navigation application. The apparatus may include instructions executable by the processor to: determine that a plurality of mobile devices are traveling along the identified route; and include information identifying the plurality of mobile devices in the communication to the core cellular network. The apparatus may include instructions executable by the processor to communicate a message to the plurality of mobile devices indicating that the plurality of mobile devices are to refrain from transmitting tracking area update messages to the core cellular network

In some aspects, the information identifying the plurality of mobile devices may include a cellular telephone number associated with each of the mobile devices. The apparatus may include instructions executable by the processor to communicate an indication to the core cellular network that the mobile device has arrived at a destination location of the identified route. The indication that the mobile device has arrived at the destination location may include a tracking area update message. The apparatus may include instructions executable by the processor to communicate to the core cellular network an indication that the mobile device has traveled at least a threshold distance outside of the identified route.

In some aspects, the mobile device is traveling along the identified route in a vehicle, and wherein the instructions to communicate the indication that the mobile device is traveling along the identified route may include instructions executable by the processor to communicate with a wireless system of the vehicle, wherein the wireless system of the vehicle is configured to provide the indication that the mobile device is traveling along the identified route to the core cellular network. The apparatus may include instructions executable by the processor to determine the identified route based at least in part on identification information associated with the vehicle.

In a third illustrative set of examples, a method for wireless communication is provided. The method may include: receiving, at a core cellular network, an indication that a mobile device is traveling along an identified route; determining a tracking area for the mobile device in response to the received communication; and sending at least one paging message to the mobile device via a cell within the determined tracking area.

In some aspects, determining the tracking area may include identifying a plurality of cells that are positioned along the identified route; and assigning at least a portion of the plurality of cells to the tracking area. The method may include receiving information identifying the mobile device and at least one additional mobile device traveling along the identified route; and communicating with a separate entity to identify a cellular provider associated with the at least one additional mobile device. The method may include communicating the identified route to the cellular provider associated with the at least one additional mobile device. The method may include communicating to the mobile device a confirmation message conveying a confirmation that the tracking area for the mobile device and the at least one additional mobile device has been determined. The method may include receiving, at the core cellular network, an indication that the mobile device has arrived at a destination location associated with the identified route.

In a fourth illustrative set of example, an apparatus for wireless communication is provided. The apparatus may include: a processor; and memory in electronic communication with the processor, the memory embodying instructions, the instructions executable by the processor to: receive, at a core cellular network, an indication that a mobile device is traveling along an identified route; determine a tracking area for the mobile device in response to the received communication; and send at least one paging message to the mobile device via a cell within the determined tracking area.

In some aspects, the instructions to determine the tracking area are further executable by the processor to: identify a plurality of cells that are positioned along the identified route; and assign at least a portion of the plurality of cells to the tracking area.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, according to one aspect of the principles described herein;

FIG. 2 shows a diagram of an example of a device mobility in a wireless communications system, according to one aspect of the principles described herein;

FIG. 3 shows a diagram of an example of communications between devices in a wireless communications system, according to one aspect of the principles described herein;

FIG. 4 shows a diagram of an example of communications between devices in a wireless communications system, according to one aspect of the principles described herein;

FIG. 5 shows a diagram of an example of communications between devices in a wireless communications system, according to one aspect of the principles described herein;

FIG. 6 shows a block diagram of one example of a mobile device, according to one aspect of the principles described herein;

FIG. 7 shows a block diagram of one example of a base station, according to one aspect of the principles described herein;

FIG. 8 shows a flowchart diagram of a method for wireless communications, according to one aspect of the principles described herein;

FIG. 9 shows a flowchart diagram of a method for wireless communications, according to one aspect of the principles described herein; and

FIG. 10 is a flowchart diagram of a method for wireless communications, in accordance with various aspects of the present disclosure.

### DETAILED DESCRIPTION

Paging messages are typically sent over a paging channel of the cellular network. As more and more mobile devices enter the tracking area and camp on the cells of the tracking area, the number of pages being sent within the tracking area increases substantially. As can be appreciated, each page consumes backhaul resources between the cells as well as between the cells and network entities. Moreover, each page consumes over-the-air resources of the cellular network. As the number of mobile devices within the tracking area increase, the likelihood of paging collisions increases, which consumes battery life of the mobile devices.

When an idle mode mobile device that is moving along a path enters a new tracking area, it sends a tracking area update to update its location information. Based on this tracking area update, the network may determine which tracking area to assign the mobile device to. When a page is destined for the mobile device, the network may attempt to page the mobile device by sending a page to the cell that received the tracking area update, as discussed above. If that page is unsuccessful, the network sends the page to all cells within the tracking area. According to current implementation, the tracking area assigned to the mobile device is based on the current location of the mobile device and does not change based on information indicating that the mobile device is traveling along a predictable or identified route.

According to aspects of the present disclosure, methods, systems, and devices are provided that may be used to improve network and/or mobile device performance based on identified behavior of a mobile device (e.g., mobile phone, laptop, tablet, etc.) user. A mobile device may determine that it is traveling along an identified route, e.g., the mobile device may autonomously identify the route or receiving an indication from another device or system that it is traveling along the route. For example, the mobile device may determine that the user, and by extension the mobile device, is traveling along a route based on information received from an application being executed on the mobile device, e.g., a global positioning system (GPS) application or navigation application residing on the mobile device. As another example, the mobile device may be traveling in a vehicle and wirelessly communicate with a different device or system, e.g., another mobile device in the vehicle and/or or wireless communication system of the vehicle, that the vehicle and by extension the mobile device are traveling along the identified route. In some examples, a vehicle navigation system may, alone or in cooperation with a wireless system of the vehicle, provide information to the mobile device indicating that the vehicle is traveling along the identified route. The mobile device may communicate this information to a core cellular network. The communication may include information indicating that the mobile device is on the identified route which will allow the mobile device to refrain from sending location area updates as it travels into new tracking areas along the route. The mobile device may send a message to the network indicating that it has reached the end of its route or its destination location, that it has deviated outside of a predefined perimeter of the route, etc.

On the core cellular network side, the network may receive the message from the mobile device indicating that the mobile device is traveling along the identified route (the specific route being taken) and a time that the mobile device started the route, e.g., a timestamp of when the mobile device sends the message to the network. The network may therefore know that the mobile device is traveling along the identified route and that the route includes certain cells. Accordingly, the network may define a tracking area for the mobile device based on the mobile device traveling along the identified route. For example, the network may assign certain cells along the route to a new tracking area for the mobile device, may assign all cells within tracking areas along the route as a mobile device specific tracking area, etc. The network may then send a page to the mobile device traveling along the route via at least one cell in the new tracking area, e.g., to a last known cell the mobile device has communicated with and then to all cells within the new tracking area. The network may also know not to expect location area updates from the mobile device as it travels along the identified route.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

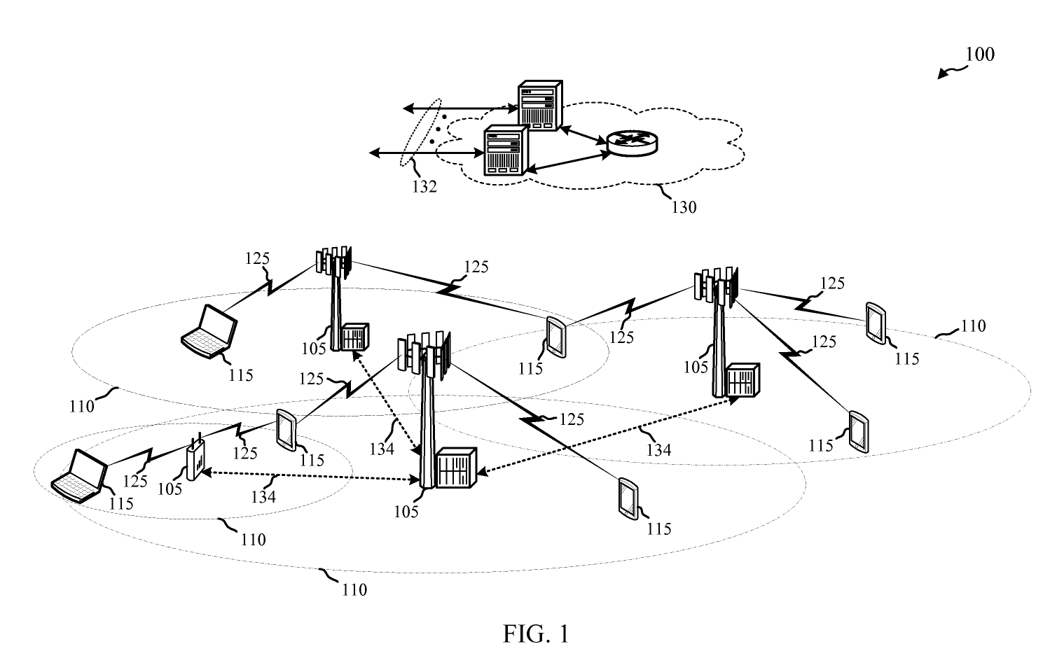

FIG. 1 illustrates an example of a wireless communications system 100 in accordance with various aspects of the disclosure. The wireless communications system 100 includes base stations (or cells) 105, mobile devices 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the mobile devices 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links

The base stations 105 may wirelessly communicate with the mobile devices 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is a Long Term Evolution (LTE) or LTE-Advanced (LTE-A) network. In LTE/LTE-A networks, the term evolved Node B (eNB) may be generally used to describe the base stations 105, while the term user equipment (UE) may be generally used to describe the mobile devices 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a term used by an organization named “3rd Generation Partnership Project” (3GPP) to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The mobile devices 115 are dispersed throughout the wireless communications system 100, and each mobile device 115 may be stationary or mobile. A mobile device 115 may also include or be referred to by those skilled in the art as a mobile station, a subscriber station, a mobile unit, a subscriber unit, a wireless unit, a remote unit, a wireless communications device, a remote device, a mobile subscriber station, an access terminal, a mobile terminal, a wireless terminal, a remote terminal, a handset, a user agent, a user equipment (UE), a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wireless local loop (WLL) station, a smartwatch, or the like. A mobile device may be able to communicate with various types of base stations and network equipment including macro eNBs, small cell eNBs, relay base stations, and the like.

The communication links 125 shown in wireless communications system 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the wireless communications system 100, base stations 105 and/or mobile devices 115 may include multiple antennas for employing antenna diversity schemes to improve communication quality and reliability between base stations 105 and mobile devices 115. Additionally or alternatively, base stations 105 and/or mobile devices 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A mobile device 115 may be configured with multiple downlink CCs and one or more uplink CCs for carrier aggregation. Carrier aggregation may be used with both FDD and TDD component carriers.

A tracking area for mobile device(s) 115 traveling along an identified route may be defined (e.g., reduced) by core network 130, e.g., a core cellular network or simply a network. The identified route may be determined based on information received at a GPS mapping application or system, e.g., a GPS application being executed on a mobile device 115 or residing in an external GPS system such as a vehicle's navigation system. Information indicative of the identified route and the mobile device(s) 115 traveling along the route may be sent to core network 130, e.g., a mobility management entity (MME) of the core cellular network. The core network 130 may identify and assign the mobile device(s) 115 to a tracking area that includes cells along the route. The mobile device(s) 115 may receive an indication of the assigned tracking area associated with the route and refrain from sending tracking area (or location area) update messages to the core network 130 as it enters new tracking areas while traveling along the route. The mobile device(s) 115 may communicate an indication to core network 130 that it has completed the route (e.g., reached a destination location) and/or that it has deviated from the route by, for example, sending a tracking area update message to core network 130.

On the network side, core network may receive the indication that the mobile device(s) 115 is traveling along the identified route and determine a tracking area for the mobile device. The tracking are may be defined based on the information associated with the identified route, e.g., may include cell(s) located along or within a predetermined distance from the route. Core network 130 may send a paging message to the mobile device(s) 115 via at least one cell within the determined tracking area, e.g., a last known cell and/or to all cells assigned to the tracking area. Accordingly, core network 130 may know not to expect tracking area update messages from the mobile device(s) 115 as it travels along the identified route. Core network 130 may receive a message from the mobile device(s) 115 indicating that it has reached a destination location along the route, that it has deviated from the route, and the like, and therefore return to traditional tracking area assignment techniques for the mobile device(s) 115.

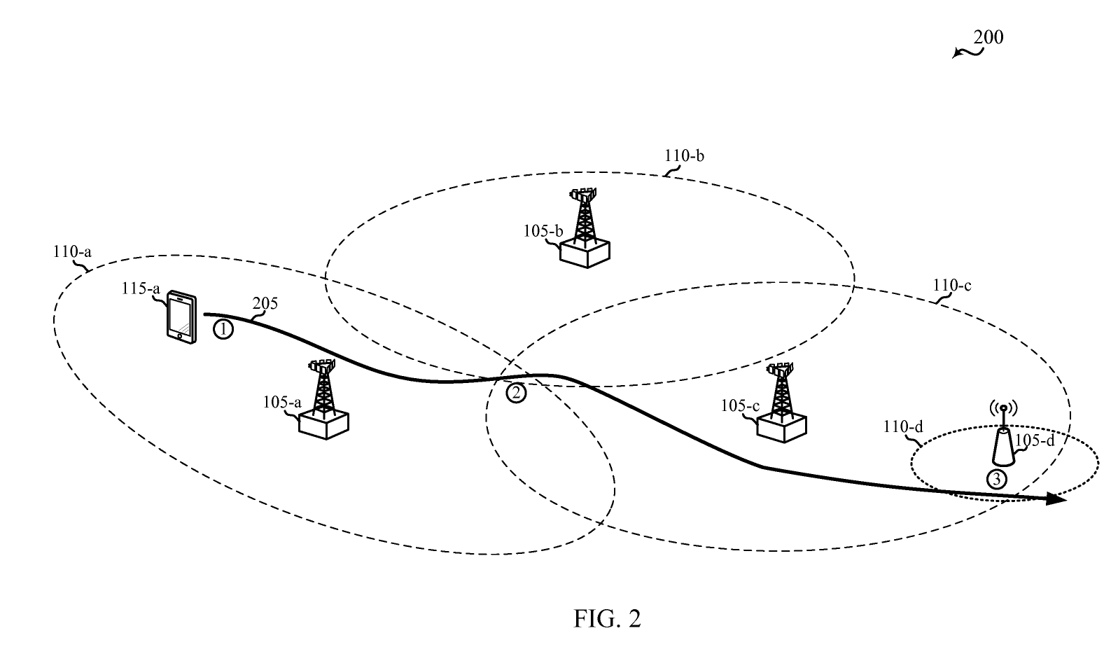

FIG. 2 shows a diagram of a simplified example of device mobility in a wireless communications system 200, according to one aspect of the principles described herein. In the wireless communications system 200 of FIG. 2, a mobile device 115-a travels along a route 205 through the coverage areas 110-a, 110-b, 110-c, 110-d of a first base station 105-a, a second base station 105-b, a third base station 105-c, and a fourth base station 105-d, respectively. The mobile device 115-a may be an example of one or more of the mobile devices 115 of FIG. 1. Similarly, the base stations 105 of FIG. 2 may be examples of one or more of the base stations 105 of FIG. 1.

Each base station 105 may represent an actual or potential serving cell for the mobile device 115-a. In the present example, the mobile device 115-a may begin at position 1 with the first base station 105-a as the serving cell, then move through the coverage area 110-a of the first base station 105-a to position 2. At position 2, the mobile device 115-a may be located at the outer reaches of the coverage area 110-a of the first base station 105-a and enter an intersection of the coverage areas 110-a, 110-b, 110-c of the first, second, and third base stations 105-a, 105-b, 105-c. At position 2, the mobile device 115-a may report a signal strength measurement of the first base station 105-a, the current serving cell, to the first base station 105-a. Accordingly, the mobile device 115-a may perform a handover procedure to connect to base station 105-b or 105-c. Similar procedures may be followed with other base stations 105 along route 205.

In conventional systems, one or more of the base stations 105-a, 105-b, and/or 105-c may be assigned to different tracking areas. As the mobile device 115-a enters different coverage areas 110-a, 110-b, 110-c, the mobile device 115-a may send location area update messages to report that it has entered into a new tracking area. The base station 105 receiving the location area update message informs the core cellular network that the mobile device 115-a is in the new tracking area. The MME then assigns the mobile device 115-a to the new tracking area and, if a page arrives for the mobile device 115-a, sends the page via at least one cell in the tracking area.

The above described scenarios may provide an example of route mobility for the mobile device 115-a. As the mobile device 115-a travels along the route 205, the mobile device 115-a may traditionally be assigned to multiple tracking areas based on the mobile device 115-a passing through the respective coverage areas 110-a, 110-b, 110-c, and 110-d. The present description provides methods, systems, and devices that may be used to improve network and/or mobile device 115-a performance based on the knowledge that the mobile device 115-a is traveling along route 205. The described techniques may provide for the mobile device 115-a determining or otherwise identifying that it is traveling along route 205. For example, an application layer of the mobile device 115-a may receive information from a navigation application (either on the mobile device 115-a or on a different system) indicating that the user has entered the destination address of the route 205 and initiated navigation of the route 205. In the example of FIG. 2, for example, the indication that the mobile device 115-a is traveling along route 205 as well as information associated with the route 205, e.g., geographic parameters corresponding to the physical path along route 205, may be used to modify location reporting parameters (e.g., the mobile device 115-a may autonomously or without direction from its serving base station send a message indicating that it is traveling along route 205). The mobile device 115-a may include in the indication message the time it started along the route 205, an identifier of the route 205, and the like. The mobile device 115-a may then withhold location area update messages as it travels through the coverage areas 110 associated with different tracking areas.

The core cellular network entity, e.g., MME, may receive the indication and access information associated with the route 205 for the mobile device 115-a. For example, the MME may access information associated with route 205 and, therefore, know that the mobile device 115-a will be traveling through tracking areas associated with coverage areas 110-a, 110-b, 110-c, etc. Accordingly, the MME may assign or otherwise define a tracking area for the mobile device 115-a based on the route 205 information. For example, the MME may define a tracking area that includes each tracking area along the route 205 (e.g., a larger tracking area). In another example, the MME may define a tracking area that includes cells with coverage areas 110 that provide service along route 205. In yet another example, the MME may define a tracking area based on an estimation of where the mobile device 115-a is along the route at any given moment based on the route start time, average travel time, etc. The MME may, in some example, access information associated with traffic patterns along route 205 to determine if congestions, accidents, etc., might delay the progress of the mobile device 115-a along route 205. Accordingly, the MME may define a tracking area for the mobile device 115-a without receiving location area update messages but, instead, based on the information associated with the route 205 the mobile device 115-a is traveling along.

In some aspects, mobile device 115-a may include the GPS navigation application. The user may enter a destination address into the navigation application which may determine a route to the destination, e.g., route 205. The navigation application may output information indicative of the identified route 205 to a different application, protocol, stack, etc., of the mobile device 115-a which may report the route information along with the mobile device 115-a identification information to the network for tracking area assignment. As the mobile device 115-a enters new tracking areas along the route 205, it may refrain from sending tracking area update messages to the network.

In some examples, the mobile device 115-a may be traveling in a vehicle that is equipped with an integrated wireless system and/or navigation system. A passenger in the vehicle may enter a destination address into the navigation system to establish the route 205. The wireless system (e.g., Bluetooth) may collect (or know) identification information (e.g., electronic serial number (ESN)) for each mobile device 115 traveling in the vehicle that it is paired with. The navigation system may output information indicative of the route 205 the vehicle will be traveling along to at least one mobile device 115, e.g., mobile device 115-a, via the wireless system. The mobile device 115 may then report the route 205 information to the network along with the identification information for each mobile device 115 traveling in the vehicle, and therefore along the route 205. The network may assign each mobile device 115 in the vehicle to the defined tracking area. In some examples, the passenger may enter the destination address into a GPS navigation application being executed on the mobile device 115, e.g., mobile device 115-a, which outputs information to the vehicle wireless system for network reporting.

In some examples, the wireless system in the vehicle may be a Bluetooth system, a Wi-Fi system, and/or may include a cellular communication system. Accordingly and in some examples, the wireless system of the vehicle may send the message to the network indicating the route 205 information and the identification information for the mobile devices 115.

The vehicle may be an automobile, a bus, a train, an aircraft, or any other vehicle for carrying passengers (and their respective mobile devices 115). For example, a bus, train, etc., may have a fixed and known route, e.g., a bus route through a city, a train traveling along tracks, and the like, as well as a wireless system. As passengers embark onto the vehicle, their mobile devices 115 may pair, associate, etc., with the wireless system for communications while in the vehicle. The vehicle wireless system in this example may collect the identification information and route 205 information and report this to the network for tracking area assignment. The wireless system of the vehicle may update the network periodically, e.g., as passengers disembark the vehicle, where the mobile device 115 of the disembarked passenger may be reassigned to a different tracking area.

In some examples, the network may receive the indication that the mobile device 115-a is traveling along the route 205 and the identification information for the mobile device 115-a and define the tracking area for the mobile device 115-a based on the route 205. For example, the network may store and/or access information associated with the route 205 and know which tracking areas, and when, the mobile device 115-a passes through along the route 205 and the time the mobile device 115-a has been traveling along the route 205. When a page arrives for the mobile device 115-a, the network may send the page to a particular cell, or group of cells located along the route 205.

In some examples, the network may determine the location of the mobile device 115-a along the route 205 based on the time the mobile device 115-a started traveling along the route 205. In some aspects, the network may determine the location based on a start time for the mobile device 115-a beginning the route 205. In some aspects, the network may access information associated with current traffic conditions and vary one or more aspects of the route 205 accordingly. For example, if traffic conditions indicate heavier than normal traffic congestion (e.g., an accident), the network may use this information when determining the location of the mobile device 115-a and which cell to send a paging message to.

In some examples, the network may create a tracking area for the mobile device 115-a based on the route 205. For example, the network may select and assign cells to the mobile device 115-a specific tracking area along the route 205. In some examples, the network may select and assign cells to a moving tracking area for the mobile device 115-a along the route 205. For example, the network may determine that the mobile device115-a is at a particular location and assign a certain number of cells ahead and behind the mobile device 115-a to the tracking area. As the mobile device 115-a moves along the route 205, the network may drop off the farthest cell behind the mobile device 115-a and add the farthest cell ahead of the mobile device 115-a to the tracking area.

In some examples, the message received by the network may indicate that multiple mobile devices 115 are traveling along the route, where at least one mobile device 115 is associated with different cellular providers. The network may access a cross-reference service using the identification information (e.g., cellular telephone number) for each mobile device 115 to determine which cellular providers are associated with particular mobile devices 115. The network may output information indicative of the route 205 information and the identification information to the other cellular providers for the mobile devices 115 associated with such cellular providers.

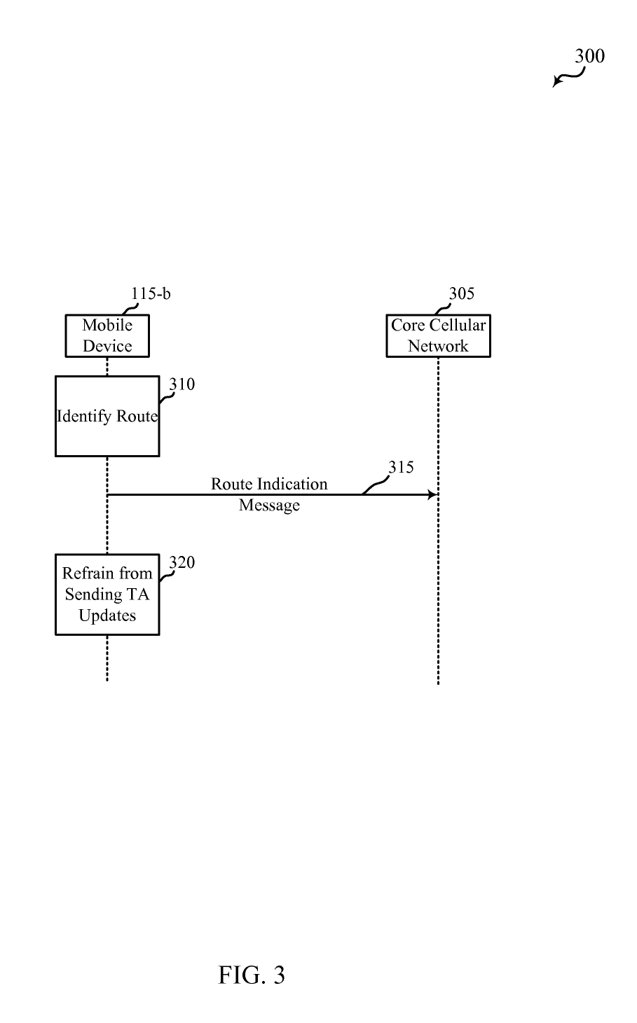

FIG. 3 shows a diagram of an example of communications between devices in a wireless communications system 300, according to one aspect of the principles described herein. The wireless communications system 300 of the present example includes a mobile device 115-b and a core cellular network 305. The wireless communications system 300 may be an example of one or more of the wireless communications systems 100 and/or 200 described above with respect to the previous figures. The mobile device 115-b may be an example of a mobile device 115 described above with respect to the previous figures. The core cellular network 305 may be an example of the core network 130 describe above with respect to the previous figures and may, in some examples, be a MME component of the core cellular network 305.

The mobile device 115-b may identify that it is traveling along a known or identified route at block 310. Generally, the mobile device 115-b may determine that it is traveling along the known route autonomously and based on information received from a navigational application, based on information received from a wireless communication system of a vehicle the mobile device 115-b is traveling in, and the like. In one example, an algorithm application may be executed by the mobile device 115-b to determine that the mobile device 115-b is traveling along the identified route. The algorithm application of the mobile device 115-b may be in communication with a navigation application executing on the mobile device 115-b, may be in communication with a navigation application executing on a different mobile device 115, and/or may be in communication with a wireless communication system of a vehicle, and receive information indicating that the mobile device 115-b is traveling along a particular route. In some examples, the algorithm application may also determine or identify other parameters associated with the mobile device 115-b traveling along the identified route, e.g., that the mobile device 115-b is traveling, that a user has initiated the navigation application to begin traveling along the route, etc., to determine that the mobile device 115-b is traveling along the identified route. In some examples, the algorithm application may determine that the mobile device 115-b is traveling along the identified route based on the mobile device 115-b pairing or associating with a wireless communication system of a vehicle. For example, the user of the mobile device 115-b may board or enter the vehicle where the mobile device 115-b connects to the vehicle's wireless communication system. The vehicle may be associated with the identified route.

At 315, the mobile device 115-b may communicate information indicating that it is traveling along the identified route to the core cellular network 305. For example, the mobile device 115-b may send a message to a serving cell that is conveyed via a backhaul link to the core cellular network 305. The message indicating that the mobile device 115-b is traveling along the route may include route identifying information, travel start time, etc. At block 320, the mobile device 115-b may refrain from sending a tracking area update message as it enters a new tracking area along the route. For example, as the mobile device 115-b enters new tracking areas along the identified route, the mobile device 115-b may determine that the new location area is associated with the identified route, that it has sent the message indicating that it is traveling along the route, and, therefore, determine that no tracking area update message is to be sent.

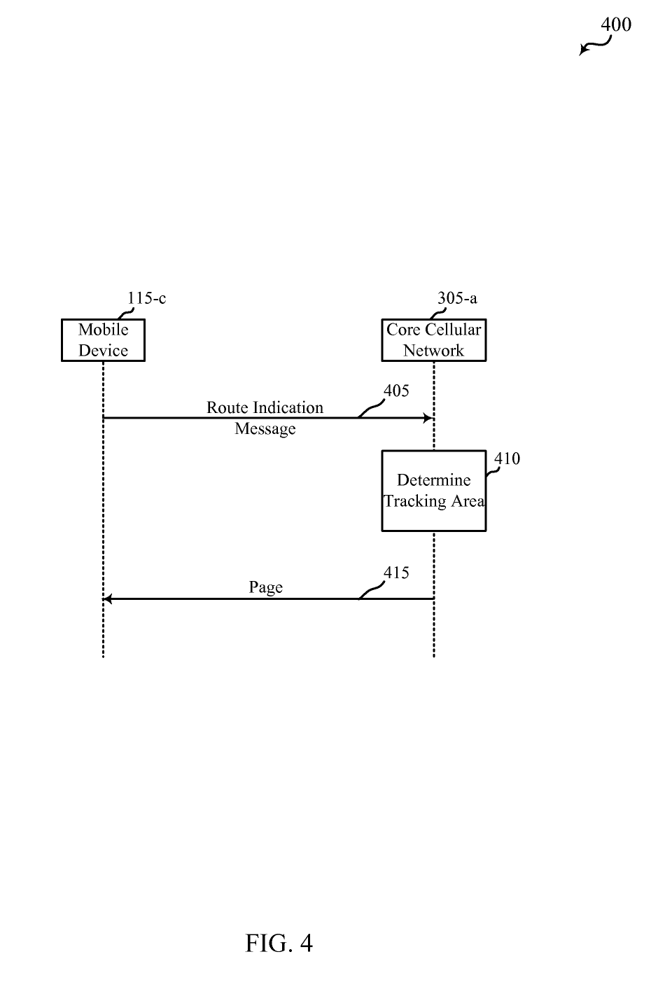

FIG. 4 shows a diagram of an example of communications between devices in a wireless communications system 400, according to one aspect of the principles described herein. The wireless communications system 400 of the present example includes a mobile device 115-c and a core cellular network 305-a. The wireless communications system 400 may be an example of one or more of the wireless communications systems 100, 200, 300 described above with respect to the previous figures. The mobile device 115-c may be an example of a mobile device 115 described above with respect to the previous figures. The core cellular network 305-a may be an example of the core network 130 describe above with respect to the previous figures and may, in some examples, be a MME.

At 405, the mobile device 115-c may communicate information indicating that it is traveling along the identified route to the core cellular network 305-a. For example, the mobile device 115-c may send a message to a serving cell that is conveyed via a backhaul link to the core cellular network 305-a. The message indicating that the mobile device 115-c is traveling along the known route may include route identifying information, travel start time, etc. In some aspects, the mobile device 115-c may re-purpose one or more information elements of an RRC message, a RACH message, etc., to convey the indication of the mobile device 115-c traveling along the identified route.

At block 410, the core cellular network 305-a may determine a tracking area for the mobile device 115-c. The core cellular network 305-a may define a tracking area for the mobile device 115-c based on the mobile device 115-c traveling along the identified route, as indicated in the message. In some examples, the core cellular network 305-a may define a tracking area that includes one or more tracking areas along the identified route, a custom tracking area for the mobile device 115-c that includes cells providing coverage for the identified route, a custom tracking area for the mobile device 115-c that includes a rolling cell count based on where along the route the mobile device 115-c is, etc. The core cellular network 305-a may define the tracking area for the mobile device 115-c without receiving location area update messages from the mobile device 115-c as it travels along the identified route. At block 415, the core cellular network 305-a may send a page via at least one cell within the tracking area. Accordingly, the core cellular network 305-a may leverage the information indicating that the mobile device 115-c is traveling along an identified route to ensure the mobile device 115-c can be paged while traveling along the route but without requiring traditional tracking area update reporting messages from the mobile device 115-c.

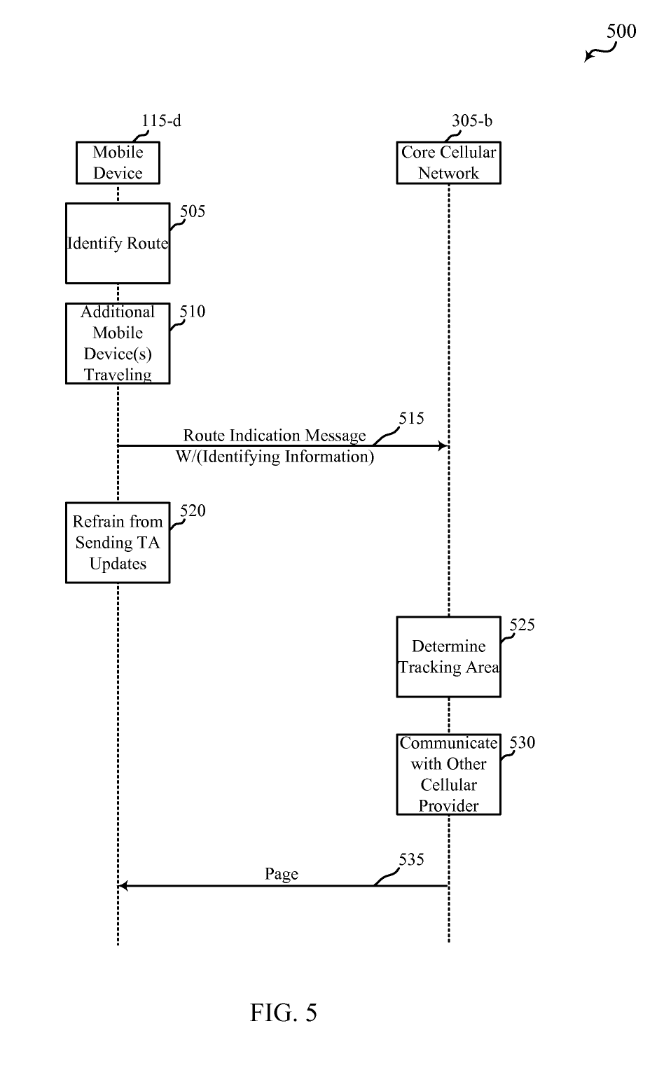

FIG. 5 shows a diagram of an example of communications between devices in a wireless communications system 500, according to one aspect of the principles described herein. The wireless communications system 500 of the present example includes a mobile device 115-d and a core cellular network 305-b. The wireless communications system 500 may be an example of one or more of the wireless communications systems 100, 200, 300, 400 described above with respect to the previous figures. The mobile device 115-d may be an example of a mobile device 115 described above with respect to the previous figures. The core cellular network 305-b may be an example of the core network 130 describe above with respect to the previous figures and may, in some examples, be a MME.

The mobile device 115-d may identify that it is traveling along a known or identified route at block 505. Generally, the mobile device 115-d may determine that it is traveling along the known route autonomously and based on information received from a navigational application, based on information received from a wireless communication system of a vehicle the mobile device 115-d is traveling in, and the like. In one example, an algorithm application may be executed by the mobile device 115-d to determine that the mobile device 115-d is traveling along the identified route. The algorithm application of the mobile device 115-d may be in communication with a navigation application executing on the mobile device 115-d, may be in communication with a navigation application executing on a different mobile device 115, and/or may be in communication with a wireless communication system of a vehicle, and receive information indicating that the mobile device 115-d is traveling along a particular route. In some examples, the algorithm application may also determine or identify other parameters associated with the mobile device 115-d traveling along the identified route, e.g., that the mobile device 115-d is traveling or otherwise not stationary, that a user has initiated the navigation application to begin traveling along the route, etc., to determine that the mobile device 115-d is traveling along the identified route. In some examples, the algorithm application may determine that the mobile device 115-d is traveling along the identified route based on the mobile device 115-d pairing or associating with a wireless communication system of a vehicle. For example, the user of the mobile device 115-d may board or enter the vehicle where the mobile device 115-d connects to the vehicle's wireless communication system. The vehicle may be associated with the identified route.

At block 510, the mobile device 115-d may identify or otherwise determine that multiple mobile devices 115 are traveling along the identified route, e.g., the mobile device 115-d and at least one additional mobile device 115. For example, the mobile device 115-d may receive information from a wireless communication system of a vehicle indicating the additional mobile device 115 are also traveling in the vehicle, and therefore along the identified route. The vehicle wireless communication system may provide an indication of all mobile devices 115 that it has paired with, has associated with, etc., to convey the indication that additional mobile devices 115 are traveling along the identified route. Additionally, identification information may also be determined for at least one of the additional mobile devices 115, e.g., an ESN, a cellular telephone number, and the like. As can be appreciated, different mobile devices 115 may be associated with different cellular service providers.

At 515, the mobile device 115-d may communicate information indicating that it is traveling along the identified route to the core cellular network 305-b. For example, the mobile device 115-d may send a message to a serving cell that is conveyed via a backhaul link to the core cellular network 305-b. The message indicating that the mobile device 115-d is traveling along the route may include route identifying information, travel start time, etc. The message conveyed at 515 may also provide the identification information for the additional mobile devices 115 traveling along the route. For example, the message may include the cellular telephone number, a layer 2 media access control (MAC) identification number, and the like, associated with the mobile devices 115. Accordingly, the core cellular network 305-b may be provided information sufficient to identify some or all of the mobile devices 115 traveling along the identified route.

At block 520, the mobile device 115-d may refrain from sending a tracking area update message as it enters a new tracking area along the route. For example, as the mobile device 115-d enters new tracking areas along the identified route, the mobile device 115-d may determine that the new location area is associated with the identified route, that it has sent the message indicating that it is traveling along the route, and, therefore, determine that no tracking area update message is to be sent.

At block 525, the core cellular network 305-b may determine a tracking area for the mobile device 115-d. The core cellular network 305-b may define a tracking area for the mobile device 115-d based on the mobile device 115-d traveling along the identified route, as indicated in the message. In some examples, the core cellular network 305-b may define a tracking area that includes one or more tracking areas along the identified route, a custom tracking area for the mobile device 115-d that includes cells providing coverage for the identified route, a custom tracking area for the mobile device 115-d that includes a rolling cell count based on where along the route the mobile device 115-d is, etc. The core cellular network 305-b may define the tracking area for the mobile device 115-d without receiving location area update messages from the mobile device 115-d as it travels along the identified route.

One or more of the additional mobile devices 115 traveling along the identified route may be associated or registered with the core cellular network 305-b and therefore the core cellular network 305-b may also define the tracking areas for such mobile devices 115. However, one or more of the additional mobile devices 115 may be associated or registered with a different core cellular network, e.g., a different cellular service provider. Accordingly at block 530, the core cellular network 305-b may communicate with such other cellular provider to provide information indicating that such mobile devices 115 are traveling along the identified route. In some examples, the core cellular network 305-b may access a cross-reference provider to determine which other cellular provider such mobile devices 115 are registered with. For example, the core cellular network 305-b may provide identification information (e.g., telephone number) to the cross-reference provider and receive information indicating which cellular provider(s) the mobile device(s) 115 are registered with. Accordingly, the core cellular network 305-b may provide the identification information for the mobile devices 115 and the identified route information to the other cellular providers for the respective mobile devices 115 for tracking area assignment and paging.

At block 535, the core cellular network 305-b may send a page via at least one cell within the tracking area. Accordingly, the core cellular network 305-b may leverage the information indicating that the mobile device 115-d is traveling along an identified route to ensure the mobile device 115-d can be paged while traveling along the route but without requiring traditional tracking area update reporting messages from the mobile device 115-d. In the situation where some of the additional mobile devices 115 traveling along the identified route are registered with the core cellular network 305-b, the core cellular network 305-b may also page such mobile devices 115 in a similar manner and without expecting tracking area update messages as the mobile devices 115 travel along the route.

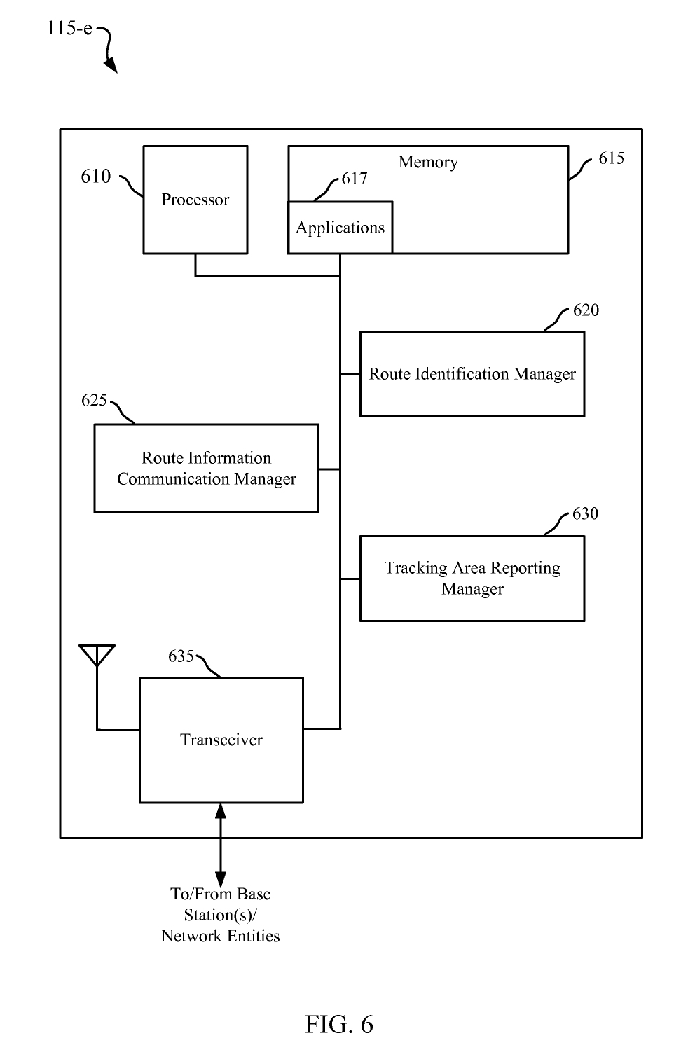

FIG. 6 shows a block diagram of one example of a mobile device 115-e, according to one aspect of the principles described herein. The mobile device 115-e may be an example of one or more of the mobile devices 115 described above with reference to the previous figures. The mobile device 115-e may include a processor 610, a memory 615, a route identification manager 620, a route information communication manager 625, a tracking area reporting manager 630, and a transceiver 635. Each of these components may be in communication, directly or indirectly.

The processor 610 may be configured to execute computer-readable program code stored by the memory 615 to implement one or more aspects of the route identification manager 620, the route information communication manager 625, the tracking area reporting manager 630, and/or the transceiver 635. The processor 610 may also execute computer-readable program code stored by the memory 615 to implement other applications 617, e.g., the described algorithm application, a navigation application, and the like.

The route identification manager 620 may be configured to monitor, control, or otherwise manage one or more aspects of identifying a route and may implement aspects of the functionality of one or more of the algorithm applications described above with respect to the previous figures. In certain examples, the route identification manager 620 may identify a route the mobile device 115-e is traveling along. The route identification manager 620 may identify the route based on data from an application layer associated with the mobile device 115-e and/or a device communicatively coupled to the mobile device 115-e.

In certain examples, a user may initiate a navigation application on the mobile device 115-e to identify the route. The navigation application may provide information to the application layer of the mobile device 115-b indicative of the route.

In certain examples, the route identification manager 620 may determine that the mobile device 115-e is traveling along the identified route in a vehicle, e.g., a car, a train, a bus, a plane, etc. The vehicle may be associated with a fixed route, e.g., a train traveling along tracks, or may be associated with a dynamic route, e.g., a route entered and selected by a user using the navigation application of the mobile device 115-e. In some aspects, the route identification manager 620 may, when the mobile device 115-e is traveling in a vehicle, communicate with a wireless system of the vehicle, e.g., a Bluetooth system, a WiFi system, and the like. The mobile device 115-e may provide identification information to the vehicle wireless system. For example, the vehicle wireless system may receive information from the mobile device 115-e associated with the identified route, e.g., from a navigation application of the mobile device 115-e. In another example, the vehicle wireless system may communicate with a navigation application of the vehicle, e.g., a vehicle navigation system, to identify that the mobile device 115-e is traveling along the identified route. In some aspects, determining the identified route may be associated with identification information for the vehicle. For example, a train may be known to travel along certain tracks and therefore identification information for the train may provide the indication of which route the mobile device 115-e is traveling along. Similarly, a bus may be associated with a fixed bus route and therefore identification information for the bus may provide the indication of which route the mobile device 115-e is traveling along.

The route information communication manager 625 may monitor, control, or otherwise manage one or more aspects of providing an indication that the mobile device 115-e is traveling along the identified route. For example, the route information communication manager 625 may communicate with core cellular network via a serving cell using the transceiver 635 to share information indicating that the mobile device 115-e is traveling along the identified route. In certain examples, the route identification manager 620 may also determine that more than one mobile device is traveling along the identified route, e.g., a plurality of mobile devices 115 in addition to mobile device 115-e. Accordingly, the message to the core cellular network may also provide identification information for the additional mobile devices 115, e.g., a cellular telephone number associated with one or more additional mobile devices 115.

In some aspects, the route information communication manager 625 may send information to the network entity associated with the known route. For example, the information reported may include, but is not limited to, transmitting information indicative of a start time when the mobile device began traveling along the predetermined route, an average travel time associated with the mobile device traveling along the predetermined route, or a travel time deviation associated with the mobile device traveling along the predetermined route.

In some aspects, the route information communication manager 625 may, when the mobile device 115-e is traveling in a vehicle, communicate with a wireless system of the vehicle, e.g., a Bluetooth system, a WiFi system, and the like. The mobile device 115-e may provide identification information to the vehicle wireless system and the wireless system of the vehicle may send the message to the core cellular network providing the indication that the mobile device 115-e is traveling along the identified route. For example, the vehicle wireless system may receive information from the mobile device 115-e associated with the identified route, e.g., from a navigation application of the mobile device 115-e, and forward or otherwise communicate such information to the core cellular network. In another example, the vehicle wireless system may communicate with a navigation application of the vehicle, e.g., a vehicle navigation system, and communicate such information to the core cellular network.

The tracking area reporting manager 630 may be configured to report the location of the mobile device 115-e to a core cellular network. In some cases, the tracking area reporting manager 630 may determine that the mobile device is traveling along the identified route, has reported this situation to the core cellular network, and therefore refrains from reporting the location of the mobile device 115-e as it enters new tracking areas along the route. In other examples, the tracking area reporting manager 630 may determine that the mobile device 115-e has deviated from the known path by traveling a certain distance outside of the route, etc., and therefore may report the location of the mobile device 115-e as it enters new tracking areas. In some examples, reporting that the mobile device 115-e has reached the destination location and/or has deviated from the route may include sending a tracking area update.

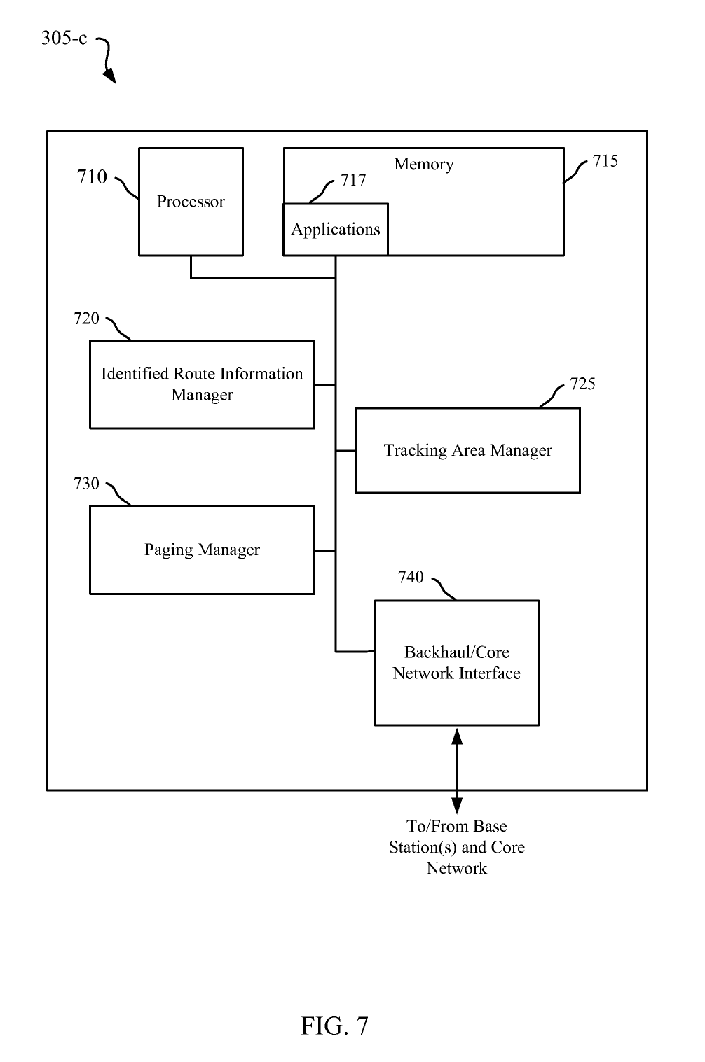

FIG. 7 shows a block diagram of a design of a core cellular network 305-c, in accordance with an aspect of the present disclosure. The core cellular network 305-c may be an example of one or more of the core network 130 and/or the core cellular networks 305 described above with respect to FIGS. 1-6. In some examples, the core cellular network 305-c may be a MME component of the core network 130.

The core cellular network 305-c may be equipped with a processor 710, a memory 715, storing applications 717, a identified route information manager 720, a tracking area manager 725, a paging manager 730, and a backhaul/core network interface 740. Each of these components may be in communication, directly or indirectly.

The processor 710 may be configured to execute computer-readable program code stored by the memory 715 to implement one or more aspects of the identified route information manager 720, the tracking area manager 725, the paging manager 730, and/or the backhaul/core network interface 740. The processor 710 may also execute computer-readable program code stored by the memory 715 to implement other applications 717.

In some cases, the core cellular network 305-c may communicate with a network through the backhaul/core network interface 740 to receive information from the base stations 105 and/or to send information to the base stations 105.

The identified route information manager 720 may be configured to receive, determine, or otherwise access information associated with one or more routes for a mobile device. The identified route information manager 720 may receive the message from the mobile device indicating that it is traveling along an identified route and output information indicative of such to other module(s) of the core cellular network 305-c. The message indicating that the mobile device is traveling along the route may include a start time the mobile device began traveling along the route, an average travel time for the mobile device traveling along the route, etc. In some examples, the identified route information manager 720 may receive the message from a different device, e.g., other than the mobile device, indicating that the mobile device is traveling along an identified route. The different device may be a different mobile device or may be a wireless system of a vehicle the mobile device is traveling in.

The identified route information manager 720 may be configured to receive information identifying additional mobile device are traveling along the identified route. For example, the additional mobile devices may be traveling in a vehicle that is traversing the route.

The tracking area manager 725 may be configured to determine, select, or otherwise define a tracking area for the mobile device as it travels along the identified route. The tracking area may be defined for the mobile device based on the information associated with the identified route the mobile device is traveling along. For example, the tracking area manager 725 may define a tracking area that includes one or more tracking areas along the route, a tracking area that includes cells whose coverage area includes the route, etc. Accordingly, the core cellular network 305-c may define the tracking area for the mobile device to provide paging coverage without receiving location area update messages from the mobile device as it travels into new tracking areas along the identified route.

In some aspects, the tracking area manager 725 may also consider additional information when defining the tracking area for the mobile device traveling along the identified route. For example, the tracking area manager 725 may consider the start time for the mobile device traveling along the route, the average travel time along the route, etc. In some examples, the tracking area manager 725 may access additional information associated with various conditions along the known route, e.g., congestion, accidents, weather, etc., and define the tracking area for the mobile device based on the conditions.

In some aspects, the tracking area manager 725 may receive messages from the mobile device indicating that it has deviated from the identified route, has reached a destination location of the route, etc., and therefore rely on tracking area update reporting from the mobile device to define tracking areas.

In some aspects where additional mobile devices are traveling along the identified route, the tracking area manager 725 may communicate with a separate entity to identify a cellular provider associated with at least one of the additional mobile devices. Accordingly, the tracking area manager 725 may communicate or otherwise provide information to the other cellular providers indicating that the additional mobile devices are traveling along the identified route for tracking area assignment and paging. Optionally, the tracking area manager 725 may convey or otherwise communicate to the mobile device a confirmation message indicating that tracking area for the mobile device and, in certain situations, the additional mobile devices, has been determined. The reporting mobile device may share the confirmation message with the additional mobile devices traveling along the identified route, e.g., using a direct wireless connection (Bluetooth, peer-to-peer (P2P), near field communication (NFC), other forms of direct connection, etc.). The reporting mobile device may share the confirmation message with the additional mobile devices individually (e.g., via a unicast transmission to each mobile device) or collectively (e.g., via a broadcast transmission).

In an example including a vehicle wireless system, the vehicle wireless system may receive the confirmation message from the tracking area manager 725 and share the confirmation message with the mobile devices traveling along the route in the vehicle. In some aspects however, the other cellular providers may communicate information to their respective mobile devices informing them that tracking area update reporting messages are not expected while traveling along the identified route. When an additional mobile device leaves the vehicle (e.g., departs the bus or arrives at their respective destination location in a car-pool situation), the departing UE may send a tracking area update message to inform the tracking area manager 725 that the UE is no longer traveling along the identified route. In another example, the original reporting mobile device may send the message indicating that the departing mobile device has left the vehicle and is no longer traveling along the identified route.

For the additional mobile devices that are registered with the core cellular network, the core cellular network may define a tracking area for those mobile devices as well. In some examples, the tracking area for the additional mobile devices may be the same as the tracking area defined for the mobile device that sent the indication.

The paging manager 730 may send a page to the mobile device via at least one cell of the defined tracking area along the identified route. For instance, the paging manager 730 may receive a page for the mobile device via the backhaul/core network interface 740 and communicate with the tracking area manager 725 to determine which cell to send the page to. The paging manager 730 may send the page via the backhaul/core network interface 740 to at least the one cell included in the tracking area defined for the mobile device.

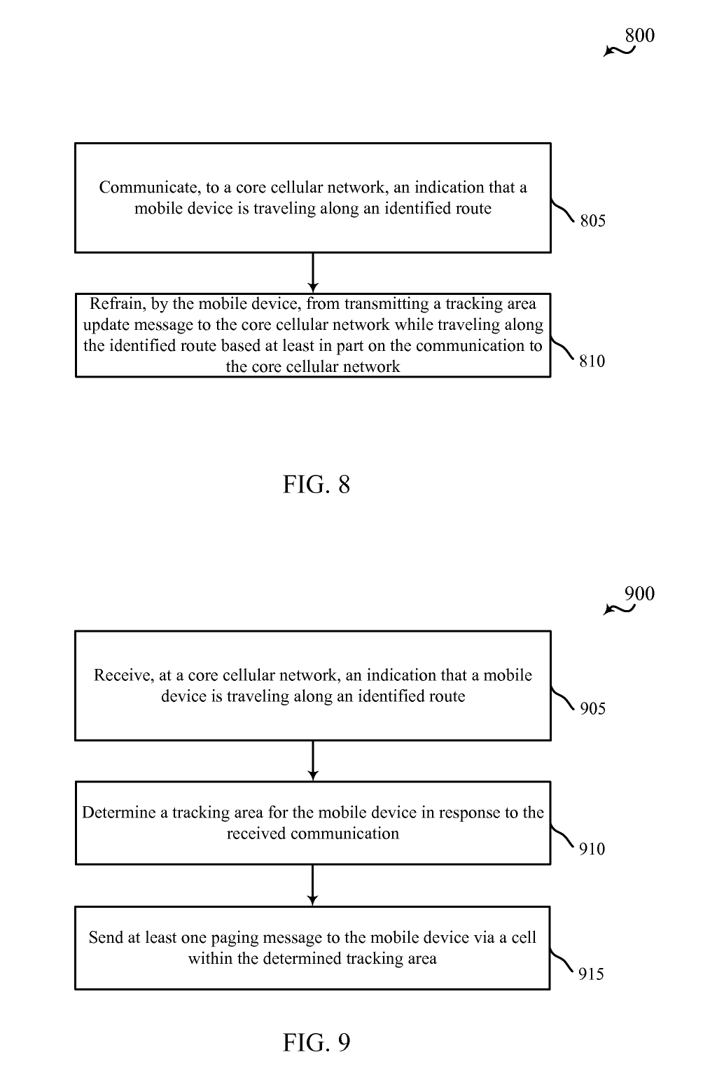

FIG. 8 is a flowchart illustrating an example of a method 800 for wireless communication, in accordance with various aspects of the present disclosure. For clarity, the method 800 is described below with reference to aspects of one or more of the mobile devices described with reference to FIGS. 1-7. In some examples, a mobile device may execute one or more sets of codes to control the functional elements of the mobile device to perform the functions described below. Additionally or alternatively, the mobile device may perform one or more of the functions described below using-purpose hardware.

At block 805, the method 800 may include the communicating a message to a core cellular network indicating that it is traveling along an predetermined route. The core cellular network may be a mobility management entity (MME) component of the core network in certain examples. The mobile device may communicating the indication to the core cellular network directly, e.g., via a serving base station, or may communicate the indication via a different mobile device or via a wireless system of a vehicle.

At block 810, the method 800 may include the mobile device refraining from transmitting a tracking area update message to the core cellular network while traveling along the identified route based at least in part on the communication to the core cellular network. For example, the mobile device may determine that it has sent the indication regarding it traveling along the identified route and, therefore, tracking area update reporting messages are not necessary while traveling along the known route.

The operation(s) at block 805 or 810 may be performed using the route identification manager 620, the route information communication manager 625, and/or the tracking area reporting manager 630, respectively, described with reference to FIG. 6.

Thus, the method 800 may provide for wireless communication. It should be noted that the method 800 is just one implementation and that the operations of the method 800 may be rearranged or otherwise modified such that other implementations are possible.

FIG. 9 is a flowchart illustrating an example of a method 900 for wireless communication, in accordance with various aspects of the present disclosure. For clarity, the method 900 is described below with reference to aspects of one or more of the core cellular networks described with reference to FIGS. 1-8. In some examples, a core cellular network may execute one or more sets of codes to control the functional elements of the core cellular network to perform the functions described below. Additionally or alternatively, the core cellular network may perform one or more of the functions described below using-purpose hardware.

At block 905, the method 900 may include the core cellular network receiving an indication from a mobile device that the mobile device is traveling along an identified route. The core cellular network may access information associated with the identified route and, therefore, may know not to expect tracking area update messages from the mobile device as it travels through different tracking areas along the identified route.

At block 910, the method 900 may include the core cellular network determining a tracking area for the mobile device in response to the received communication. For example, the core cellular network may access information associated with the identified route and determine which tracking areas cover the route. Accordingly, the core cellular network may define the tracking area for the mobile device that includes the tracking areas of the route. In another example, the core cellular network may define the tracking area to include one or more of the cells that provide coverage along the identified route. The core cellular network may define a tracking area that includes a rolling cell count based on where the mobile device is along the route, e.g., based on when the mobile device started along the route and how much time has passed.

At block 915, the method 900 may include the core cellular network sending a page to the mobile device via at least one cell within the determined tracking area. For example, the core cellular network may send the page to one cell within the tracking area, to a subset of cells within the tracking area, or to all cells within the tracking area. In certain aspects, the core cellular network may send the page to one cell and, if there is no response from the mobile device, send the page to additional cells to cover a larger area.

The operation(s) at block 905, 910, or 915 may be performed using the identified route information manager 720, the tracking area manager 725, and/or the paging manager 730, respectively, described with reference to FIG. 7.

Thus, the method 900 may provide for wireless communication. It should be noted that the method 900 is just one implementation and that the operations of the method 900 may be rearranged or otherwise modified such that other implementations are possible.

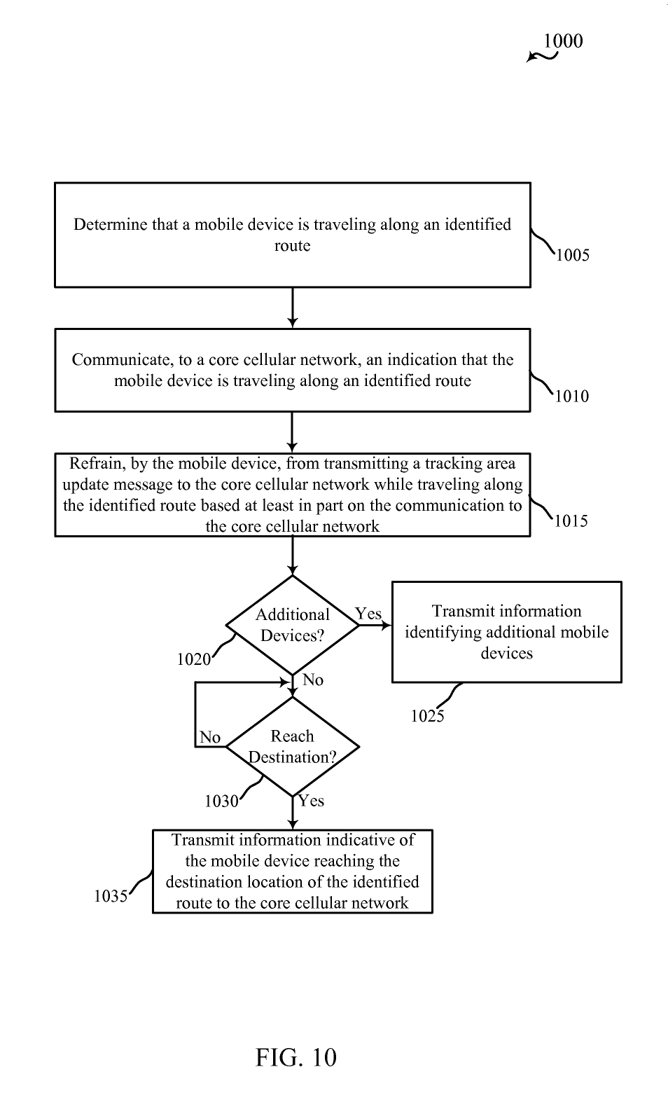

FIG. 10 is a flowchart illustrating an example of a method 1000 for wireless communication, in accordance with various aspects of the present disclosure. For clarity, the method 1000 is described below with reference to aspects of one or more of the mobile devices described with reference to FIGS. 1-8. In some examples, a mobile device may execute one or more sets of codes to control the functional elements of the mobile device to perform the functions described below. Additionally or alternatively, the mobile device may perform one or more of the functions described below using-purpose hardware.

At block 1005, the method 1000 may include the mobile device determining that it is traveling along an identified route. The mobile device may make this determination based on information received from an application, e.g., a navigation application, residing on the mobile device, based on information received from a different mobile device traveling along the identified route, and/or based on information received from a wireless system of a vehicle that the mobile device is traveling in. In certain aspects, the mobile device may determine that it has departed an origination location of the route within a given timeframe and is traveling along a particular path (e.g., highway, road, interstate, etc.). Accordingly, the mobile device may trigger the initiation of the determination that it is traveling along the identified route. The mobile device may make the determination that it is traveling along the identified route to within a predefined degree of confidence.

At block 1010, the method 1000 may include the mobile device communicating an indication to a core cellular network that it is traveling along the identified route. The core cellular network may be a mobility management entity (MME) component of the core cellular network in certain examples. The mobile device may indicate to the core cellular network that it is traveling along the identified route by transmitting an RRC connection request message that uses one or more information elements to convey the indication as well as to convey a route identifier, e.g., use a random value portion of the mobile device identity information element to convey the route identifier in combination with an establishment cause associated with traveling along the identified route. In another example, the mobile device may use portions of a random access preamble message to convey the indication and pass the route identifier information.

At block 1015, the method 1000 may include the mobile device refraining from transmitting a tracking area message to the core cellular network while traveling along the identified route based at least in part on the communication to the core cellular network. For example, the mobile device may determine that it has sent the indication regarding it traveling along the identified route and, therefore, tracking area update reporting messages are not necessary while traveling along the route.

At block 1020, the method 1000 may include the mobile device determining whether additional mobile devices are traveling along the identified route. For example, the mobile device may be in communication with a wireless system of a vehicle the mobile device is traveling in and receive the indication that additional mobile devices are traveling along the identified route from the vehicle's wireless system. The indication may include information identifying the additional mobile devices, e.g., an ESN, a MAC address, and/or a cellular telephone number, of the additional mobile devices. If additional mobile devices are traveling along the identified route, at block 1025 the method 1000 may include the mobile device transmitting information to the core cellular network including the identification information for the additional mobile devices.

At block 1030, the method 1000 may include the mobile device determining if it has reached a destination location of the identified route. For example, the mobile device may determine that it has reached a work location, a home location, and the like, associated with the identified route. The mobile device may make this determination based on communicating with a known base station, cell, or access point (e.g., a home Wi-Fi, a work wireless network, etc.). If the mobile device determines that it has not reached the destination location, the method 1100 may include returning to block 1030 to continue to monitor for whether the mobile device has reached the destination location. If the mobile device determines that it has reached the destination location, at block 1035 the method 1000 may include the mobile device transmitting information to the core cellular network indicating that it has reached the destination location of the identified route. In some examples where there are a plurality of mobile devices traveling in the vehicle, the mobile device may also transmit information to the core cellular network indicating that the other mobile devices traveling in the vehicle and along the identified route have reached the destination location. Accordingly, the mobile device may determine that it has ended traveling along the identified route and, therefore, may revert to normal tracking area update reporting messages with the core cellular network.

The operation(s) at block 1005, 1010, 1015, 1020, 1025, 1030, or 1035 may be performed using the route identification manager 620, the route information communication manager 625, and/or the tracking area reporting manager 630, respectively, described with reference to FIG. 6.

Thus, the method 1000 may provide for wireless communication. It should be noted that the method 1000 is just one implementation and that the operations of the method 1000 may be rearranged or otherwise modified such that other implementations are possible.

In some examples, aspects from two or more of the methods 800-1000 may be combined. It should be noted that the methods 800, 900, etc. are just example implementations, and that the operations of the methods 800-1000 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
communicating, to a core cellular network, an indication that a mobile device is traveling along an identified route; and
refraining, by the mobile device, from transmitting a tracking area update message to the core cellular network while traveling along the identified route based at least in part on the communication to the core cellular network.

2. The method of claim 1, further comprising:
identifying the route based at least in part on application layer data associated with at least one of: the mobile device or a device communicatively coupled with the mobile device.

3. The method of claim 2, further comprising:
initiating a navigation application to identify the identified route;
wherein the application layer data associated with the mobile device comprises data from the navigation application.

4. The method of claim 1, further comprising:
determining that a plurality of mobile devices are traveling along the identified route; and
including information identifying the plurality of mobile devices in the communication to the core cellular network.

5. The method of claim 4, further comprising:
communicating a message to the plurality of mobile devices indicating that the plurality of mobile devices are to refrain from transmitting tracking area update messages to the core cellular network.

6. The method of claim 4, wherein the information identifying the plurality of mobile devices comprises a cellular telephone number associated with each of the mobile devices.

7. The method of claim 1, further comprising:
communicating an indication to the core cellular network that the mobile device has arrived at a destination location of the identified route.

8. The method of claim 7, wherein the indication that the mobile device has arrived at the destination location comprises a tracking area update message.

9. The method of claim 1, further comprising:
communicating to the core cellular network an indication that the mobile device has traveled at least a threshold distance outside of the identified route.

10. The method of claim 1, wherein the mobile device is traveling along the identified route in a vehicle, and wherein communicating the indication that the mobile device is traveling along the identified route comprises:
communicating with a wireless system of the vehicle, wherein the wireless system of the vehicle is configured to provide the indication that the mobile device is traveling along the identified route to the core cellular network.

11. The method of claim 10, further comprising:
determining the identified route based at least in part on identification information associated with the vehicle.

12. An apparatus for wireless communication, comprising:
a processor; and
memory in electronic communication with the processor, the memory embodying instructions, the instructions executable by the processor to:
communicate, to a core cellular network, an indication that a mobile device is traveling along an identified route; and
refrain, by the mobile device, from transmitting a tracking area update message to the core cellular network while traveling along the identified route based at least in part on the communication to the core cellular network.

13. The apparatus of claim 12, further comprising instructions executable by the processor to:
identify the route based at least in part on application layer data associated with at least one of: the mobile device or a device communicatively coupled with the mobile device.

14. The apparatus of claim 13, further comprising instructions executable by the processor to:
initiate a navigation application to identify the identified route;
wherein the application layer data associated with the mobile device comprises data from the navigation application.

15. The apparatus of claim 12, further comprising instructions executable by the processor to:
determine that a plurality of mobile devices are traveling along the identified route; and
include information identifying the plurality of mobile devices in the communication to the core cellular network.

16. The apparatus of claim 15, further comprising instructions executable by the processor to:
communicate a message to the plurality of mobile devices indicating that the plurality of mobile devices are to refrain from transmitting tracking area update messages to the core cellular network.

17. The apparatus of claim 15, wherein the information identifying the plurality of mobile devices comprises a cellular telephone number associated with each of the mobile devices.

18. The apparatus of claim 12, further comprising instructions executable by the processor to:
communicate an indication to the core cellular network that the mobile device has arrived at a destination location of the identified route.

19. The apparatus of claim 18, wherein the indication that the mobile device has arrived at the destination location comprises a tracking area update message.

20. The apparatus of claim 12, further comprising instructions executable by the processor to:
communicate to the core cellular network an indication that the mobile device has traveled at least a threshold distance outside of the identified route.

21. The apparatus of claim 12, wherein the mobile device is traveling along the identified route in a vehicle, and wherein the instructions to communicate the indication that the mobile device is traveling along the identified route comprises instructions executable by the processor to:
communicate with a wireless system of the vehicle, wherein the wireless system of the vehicle is configured to provide the indication that the mobile device is traveling along the identified route to the core cellular network.

22. The apparatus of claim 21, further comprising instructions executable by the processor to:
determine the identified route based at least in part on identification information associated with the vehicle.

23. A method for wireless communication, comprising:
receiving, at a core cellular network, an indication that a mobile device is traveling along an identified route;
determining a tracking area for the mobile device in response to the received communication; and
sending at least one paging message to the mobile device via a cell within the determined tracking area.

24. The method of claim 23, wherein determining the tracking area comprises:
identifying a plurality of cells that are positioned along the identified route; and
assigning at least a portion of the plurality of cells to the tracking area.

25. The method of claim 23, further comprising:
receiving information identifying the mobile device and at least one additional mobile device traveling along the identified route; and
communicating with a separate entity to identify a cellular provider associated with the at least one additional mobile device.

26. The method of claim 25, further comprising:
communicating the identified route to the cellular provider associated with the at least one additional mobile device.

27. The method of claim 25, further comprising:
communicating to the mobile device a confirmation message conveying a confirmation that the tracking area for the mobile device and the at least one additional mobile device has been determined.

28. The method of claim 23, further comprising:
receiving, at the core cellular network, an indication that the mobile device has arrived at a destination location associated with the identified route.

29. An apparatus for wireless communication, comprising:
a processor; and
memory in electronic communication with the processor, the memory embodying instructions, the instructions executable by the processor to:
receive, at a core cellular network, an indication that a mobile device is traveling along an identified route;
determine a tracking area for the mobile device in response to the received communication; and
send at least one paging message to the mobile device via a cell within the determined tracking area.

30. The apparatus of claim 29, wherein the instructions to determine the tracking area are further executable by the processor to:
identify a plurality of cells that are positioned along the identified route; and
assign at least a portion of the plurality of cells to the tracking area.
